(19) United States
(12) Patent Application Publication
(10) Pub. No.: US 2016/0109010 A1
(43) Pub. Date: Apr. 21, 2016

(54) HYBRID DRIVE MODULE WITH OPTIMIZED ELECTRIC MOTOR ATTACHMENT

(71) Applicant: Schaeffler Technologies AG & Co. KG, Herzogenaurach (DE)

(72) Inventors: Patrick M. Lindemann, Wooster, OH (US); Scott Schrader, Canton, OH (US)

(21) Appl. No.: 14/861,337

(22) Filed: Sep. 22, 2015

Related U.S. Application Data
(60) Provisional application No. 62/064,686, filed on Oct. 16, 2014.

(51) Int. Cl. F16H 41/28; B60K 6/36; B23P 15/00; F16H 45/02

(52) U.S. Cl. CPC F16H 41/28; F16H 45/02; B60K 6/36; B23P 15/00; Y10S 903/909; B60Y 2400/426; B60Y 2200/92; B23P 2700/50

(57) ABSTRACT

A hybrid drive module with a torque converter and a rotor carrier. The torque converter includes a cover made of a piece of material, an impeller and a turbine. The rotor carrier is made of a piece of aluminum different from the piece of material, is arranged to non-rotatably connect to a rotor for an electric motor, and includes a connection element. The connection element: is formed from the piece of aluminum and includes at least one rivet non-rotatably connecting the cover and the rotor carrier; or is made of a piece of non-aluminum material, partially embedded in the piece of aluminum, and non-rotatably connected to the cover.

### CROSS-REFERENCE TO RELATED APPLICATIONS

This application claims the benefit under 35 U.S.C. §119(e) of U.S. Provisional Patent Application No. 62/064,686, filed Oct. 16, 2014, which application is incorporated herein by reference in its entirety.

### TECHNICAL FIELD

The present disclosure relates generally to a hybrid module including a torque converter, an aluminum rotor carrier for an electric motor, and a connection element non-rotatably connecting the rotor carrier to a cover for the torque converter. In particular, the connection element includes a rivet or a non-aluminum plate non-rotatably connected to the cover.

### BACKGROUND

It is known to use a hybrid combination of an internal combustion engine and an electric motor to power a vehicle. Typically, a rotor carrier for the rotor of the electric motor is non-rotatably connected to a cover for a torque converter. There are three known methods of connecting the rotor carrier and the cover: casting the carrier and the cover in one piece using aluminum; welding a steel carrier to a steel cover; and bolting a steel carrier to the cover. The first method results in a weak attachment to the impeller for the torque converter and a generally less durable cover. The second and third methods increase parts count and/or increase inertia due to the increased weight associated with steel versus aluminum. Steel and aluminum cannot be welded together using known techniques.

### BRIEF SUMMARY

The present disclosure broadly includes a hybrid drive module with a torque converter and a rotor carrier. The torque converter includes a cover made of a piece of material, an impeller and a turbine. The rotor carrier is made of a piece of aluminum different from the piece of material, is arranged to non-rotatably connect to a rotor for an electric motor, and includes a connection element. The connection element is: formed from the piece of aluminum and includes at least one rivet non-rotatably connecting the cover and the rotor carrier; or is made of a piece of non-aluminum material, partially embedded in the piece of aluminum, and non-rotatably connected to the cover.

The present disclosure broadly includes a method of assembling a hybrid drive module including a rotor carrier made of a first piece of material and including at least one rivet, the method including: inserting the at least one rivet through at least one respective opening in a cover for a torque converter, the cover made of a second piece of material different from the first piece of material; deforming the at least one rivet to fixedly secure the rotor to the cover; fixing an impeller for the torque converter to the cover; and installing a turbine and stator for the torque converter.

The present disclosure broadly includes a hybrid drive module with a torque converter and a rotor carrier. The torque converter includes a cover made of a piece of material, an impeller and a turbine. The rotor carrier is formed of a piece of aluminum different from the piece of material, is arranged to non-rotatably connect to a rotor for an electric motor, and, includes a connection element formed of a piece of non-aluminum material different from the piece of material, partially embedded in the piece of aluminum, and non-rotatably connected to the rotor carrier and the cover.

### BRIEF DESCRIPTION OF THE DRAWINGS

The nature and mode of operation of the present disclosure will now be more fully described in the following detailed description of the disclosure taken with the accompanying drawing figures, in which:

FIG. 1 is a perspective view of a cylindrical coordinate system demonstrating spatial terminology used in the present application;

FIG. 2 is a cross-sectional view of a hybrid power module with an integral rivet;

FIG. 3 is a cross-sectional view of a hybrid power module with an embedded rivet; and,

FIG. 4 is a cross-sectional view of a hybrid power module with an embedded plate.

### DETAILED DESCRIPTION OF THE DISCLOSURE

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims. For example, the term powertrain is defined as an intervening mechanism by which power is transmitted from an engine to an axle that it drives and can include components such as a torque converter, electric motor, transmission, and driveshaft.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the disclosure. The assembly of the present disclosure could be driven by hydraulics, electronics, and/or pneumatics.

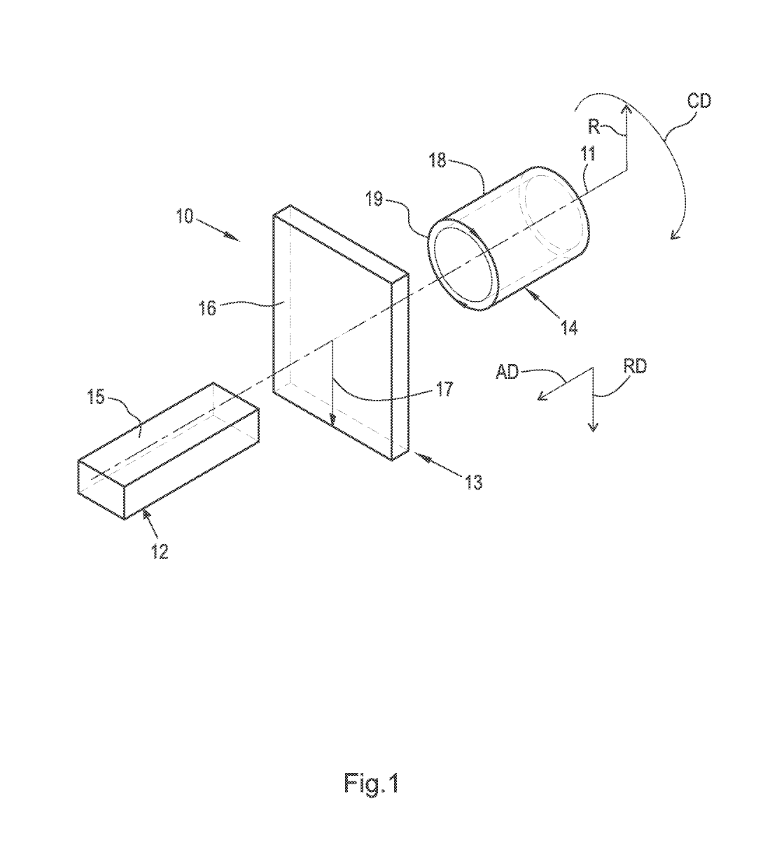

FIG. 1 is a perspective view of cylindrical coordinate system 10 demonstrating spatial terminology used in describing the present disclosure. The present disclosure is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 is passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

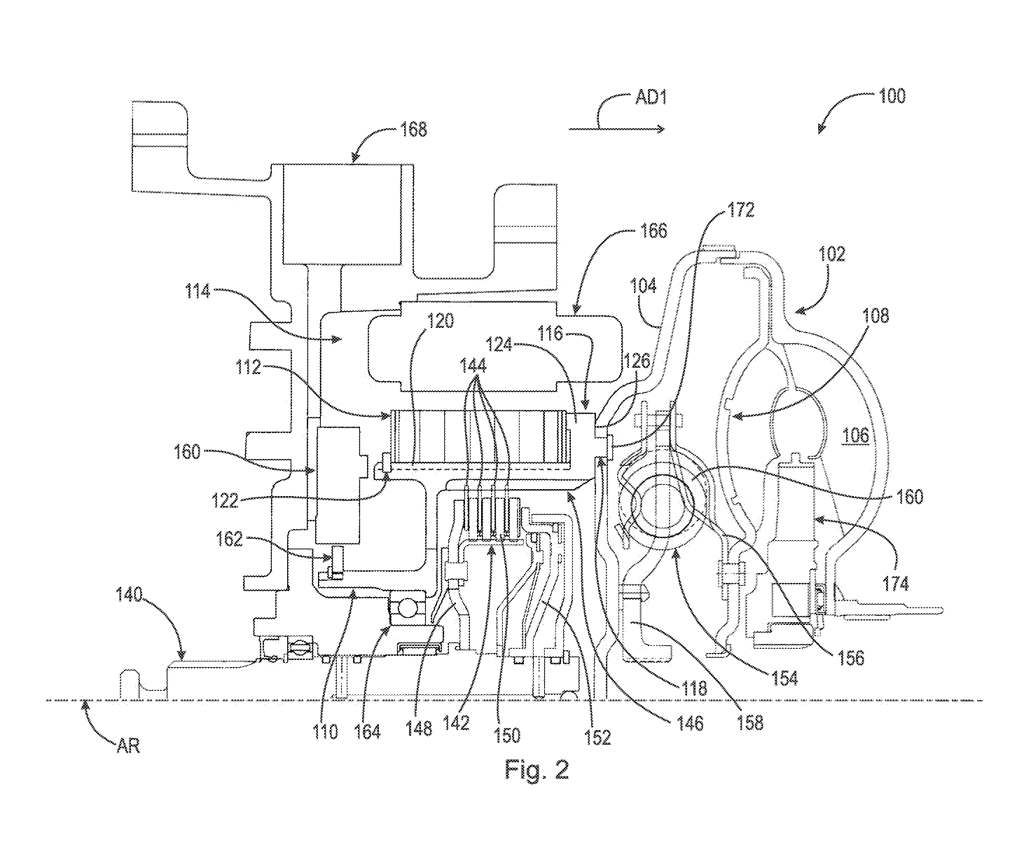

FIG. 2 is a cross-sectional view of hybrid power module 100 with an integral rivet.

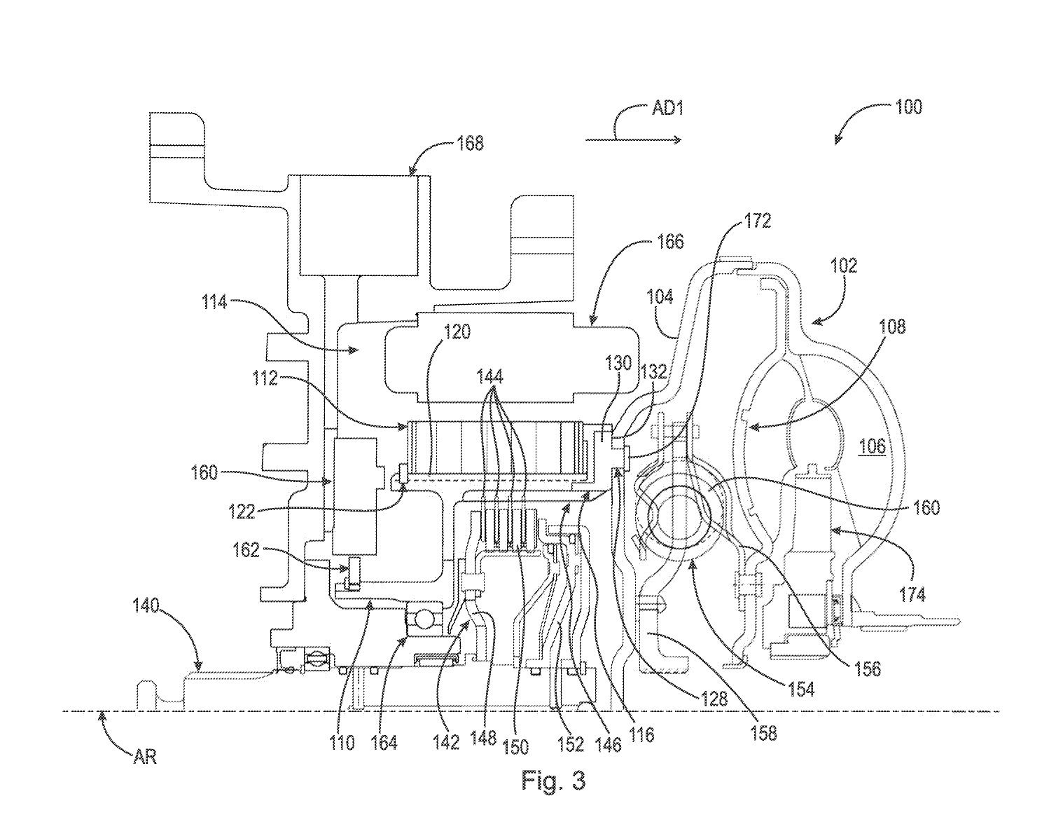

FIG. 3 is a cross-sectional view of hybrid power module 100 with an embedded rivet.

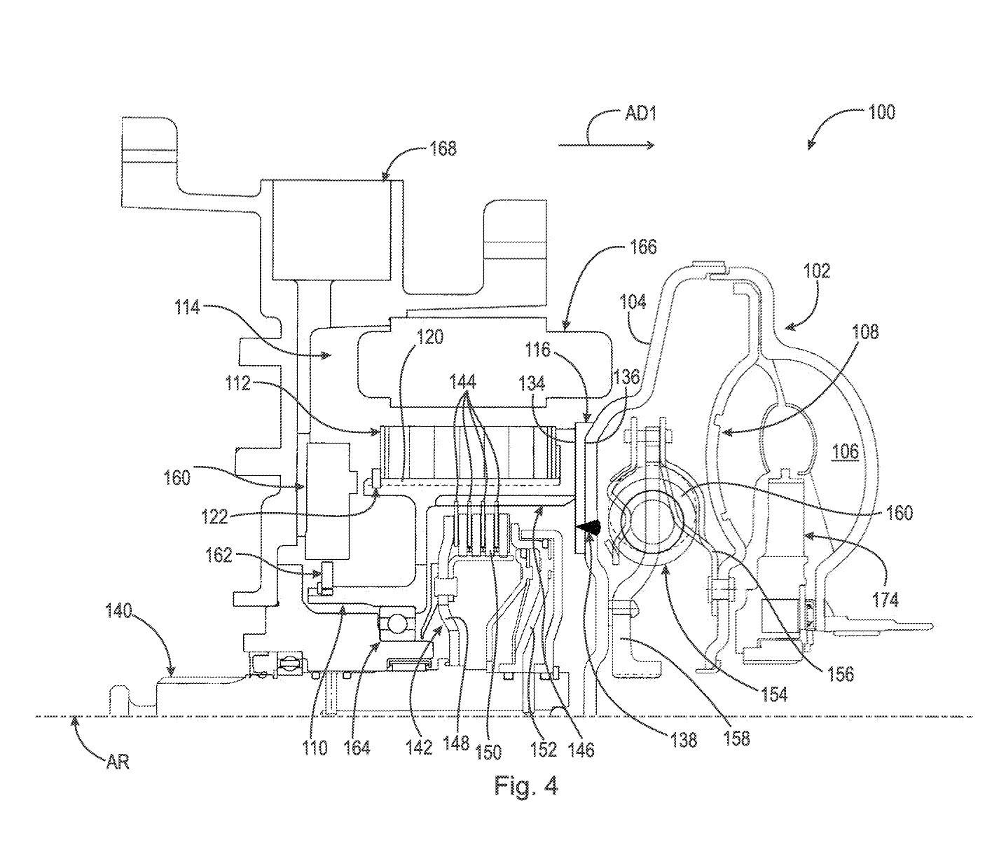

FIG. 4 is a cross-sectional view of hybrid power module 100 with an embedded plate. The following should be viewed in light of FIGS. 2 through 4. Module 100 includes: axis of rotation AR; torque converter 102 including cover 104, impeller 106 and turbine 108; and rotor carrier 110. Carrier 110 is made of a piece of aluminum different from a piece of material forming cover 104, is arranged to non-rotatably connect to rotor 112 for electric motor 114, and includes connection element 116. By “non-rotatably connect” we mean that two or more elements are connected so that whenever one of the elements rotates the rest of the elements rotate and vice versa.

In an example embodiment, for example as shown in FIG. 2, element 116 is formed from the piece of aluminum forming carrier 110 and includes at least one rivet 118 (hereinafter referred to as rivet 118) non-rotatably connecting cover 104 and carrier 110. That is, rivet 118 is integral to carrier 110.

In an example embodiment, for example as shown in FIGS. 3 and 4, element 116 is made of a non-aluminum material, is partially embedded in the piece of aluminum forming carrier 110, and is non-rotatably connected to cover 104.

In an example embodiment, module 100 includes motor 114. In an example embodiment, carrier 110 is arranged to non-rotatably connect to rotor 112 via splines 120 and is axially restrained by snap ring 122.

In the example embodiment of FIG. 2, rotor carrier 110 includes shoulder portion 124 with surface 126. Rivet 118 extends from surface 126 in axial direction AD1. At least a portion of surface 126 is engaged with cover 104. In an example embodiment, at least a portion of surface 126 is in contact with cover 104. Rotor carrier 110 is non-rotatably connected to cover 104 solely by rivet 118. That is, no other fasteners and no weld is used to secure carrier 110 to cover 104. In an example embodiment, element 116 includes twenty-four integrated rivets 118 arranged in a symmetrical pattern. It should be appreciated, however, that using different numbers of rivets and different patterns is possible and considered to be within the scope of the disclosure as claimed.

In the example embodiment of FIG. 3, connection element 116 is made of the non-aluminum material, for example, steel, and includes at least one rivet 128 (hereinafter referred to as rivet 128) non-rotatably connecting the rotor carrier and the cover. Connection element 110 includes shoulder portion 130 with surface 132. Rivet 128 extends from surface 132 in axial direction AD1. At least a portion of surface 132 is engaged with cover 104. In an example embodiment, at least a portion of surface 132 is in contact with cover 104. Rotor carrier 110 is non-rotatably connected to cover 104 solely by rivet 128. That is, no other fasteners and no weld is used to secure carrier 110 to cover 104. It should be understood that the material of construction for element 116 is not limited to steel and that other non-aluminum materials may be used.

In an example embodiment, element 116 includes twenty-four integrated rivets 128 arranged in a symmetrical pattern. It should be appreciated, however, that using different numbers of rivets and different patterns is possible and considered to be within the scope of the disclosure as claimed. In an example embodiment, to manufacture carrier 110, element 116 in FIG. 3 is placed within a casting mold (not shown) for rotor carrier 110. Molten aluminum is poured into the casting mold and solidifies about element 116 such that element 116 is partially embedded in carrier 110 and securely connected to carrier 110.

In the example embodiment of FIG. 4, connection element 116 is made of the non-aluminum material, for example, steel, and is in the form of an annular plate. Element 116 includes surface 134 in contact with carrier 110 and surface 136 in contact with cover 104. Element 116 is non-rotatably connected to cover 104 by at least one weld 138. Rotor carrier 110 is non-rotatably connected to cover 104 solely by the at least one weld 138. That is, no fastener is used to secure carrier 110 to cover 104. It should be understood that the material of construction for element 116 is not limited to steel and that other non-aluminum materials, suitable for welding, may be used.

In an example embodiment, to manufacture carrier 110, element 116 in FIG. 4 is placed within a casting mold (not shown) for rotor carrier 110. Molten aluminum is poured into the casting mold and solidifies about element 116 such that element 116 is partially embedded in carrier 110 and securely connected to carrier 110.

The following is applicable to FIGS. 2 through 4. In an example embodiment, module 100 is arranged to engage, or includes, input part 140, and includes clutch 142. Part 140 is arranged to receive torque, for example, from an internal combustion engine (not shown). Clutch 142 includes at least one clutch 144 plate non-rotatably connected rotor carrier 110 via splines 146, inner carrier 148 non-rotatably connected to input part 140, at least one clutch plate 150 non-rotatably connected to inner carrier 148, and piston plate 152 axially displaceable to open and close clutch 142. Due to the non-rotatable connection of carrier 110 and cover 104, the electric motor is always able to rotate cover 104.

Clutch 142 enables selective connection of input part 140 and cover 104. Thus, module 100 can function in at least three modes. For a first mode, clutch 142 is open and electric motor 114 is the only source of torque for torque converter 102. For a second mode, clutch 142 is closed, electric motor 114 is not driving torque converter 102, and the only source of torque for torque converter 102 is part 140 via clutch 142. For a third mode, clutch 142 is closed and motor 114 is used to provide torque to part 140 to start an internal combustion engine (not shown) attached to part 140.

In an example embodiment, torque converter 102 includes torsional vibration damper 154 with input part 156 non-rotatably connected to turbine 108, output part 158 arranged to connect to a transmission input shaft (not shown), and at least one spring 160 engaged with parts 156 and 158.

In an example embodiment, carrier 110 is arranged to engage resolver 160, carrier 110 is arranged to non-rotatably engage rotor resolver 162, and bearing 164 supports carrier 110. Stator 166 of motor 114 is non-rotatably connected to housing 168.

Advantageously, module 100 eliminates the problems noted above with respect to connecting an electric motor to a torque converter cover. Each of the example embodiments in FIGS. 2 through 4 includes rotor carrier 110 made of aluminum, which advantageously reduces the weight and rotational inertia of the carrier, and a cover 104 made of steel, reducing the cost of manufacturing cover 104 and increasing the durability of cover 104. The example embodiment of FIG. 2 advantageously reduces parts count, since rivet(s) 118 is integral to carrier 110. Further, there is no need for any other fasteners or welds.

The example embodiment of FIG. 3 uses steel for element 116 in instances where greater durability is desired for the interface of carrier 110 and cover 104 and the use of rivets to connect carrier 110 and cover 104 is desired. The example embodiment of FIG. 4 uses steel for element 116 in instances where greater durability is desired for the interface of carrier 110 and cover 104 and the use of welding to connect carrier 110 and cover 104 is desired.

Disclosed herein is a method of assembling a hybrid drive module. Although the method is presented as a sequence for clarity, no order should be inferred from the sequence unless explicitly stated. The hybrid drive module includes rotor carrier 110 made of a first piece of material and including at least one rivet, such as rivet 118 or 128. The method includes: inserting the at least one rivet through at least one respective opening 170 in cover 104 for torque converter 102, the cover made of a second piece of material different from the first piece of material; deforming the at least one rivet to fixedly secure the rotor to the cover, for example forming head 172 of the at least one rivet; fixing impeller 106 for torque converter 102 to cover 104; and installing turbine 108 and stator 174 for torque converter 102.

In an example embodiment, the at least one rivet is rivet 118 formed from the second piece of material, for example as shown in FIG. 2. In an example embodiment, the at least one rivet is rivet 128 formed of a third piece of material, different from the first piece of material and fixed to the first piece of material, for example as shown in FIG. 3.

In an example embodiment, the method includes: non-rotatably connecting at least one clutch plate 144 for disconnect clutch 142 to the rotor carrier; non-rotatably connecting inner carrier 148 for disconnect clutch 142 to input part 140 arranged to receive torque for the hybrid drive module; non-rotatably connecting at least one second clutch plate 150 for disconnect clutch 142 to inner carrier 148; and installing piston plate 152 axially displaceable to open and close clutch 142.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A hybrid drive module, comprising:
a torque converter including:
a cover formed of a first piece of material;
an impeller; and,
a turbine; and,
a rotor carrier:
made of a second piece of material different from the first piece of material;
arranged to non-rotatably connect to a rotor for an electric motor; and,
including a connection element:
formed from the second piece of material and including at least one first rivet non-rotatably connecting the cover and the rotor carrier; or,
made of a third piece of material partially embedded in the second piece of material and non-rotatably connected to the cover.

2. The hybrid drive module of claim 1, wherein:
the connection element is formed from the second piece of material;
the rotor carrier includes a shoulder portion with a surface;
the at least one first rivet extends from the surface in an axial direction; and,
at least a portion of the surface is engaged with the cover.

3. The hybrid drive module of claim 2, wherein the rotor carrier is non-rotatably connected to the cover solely by the at least one first rivet.

4. The hybrid drive module of claim 1, wherein the connection element:
is made of the third piece of material; and,
includes at least one second rivet non-rotatably connecting the rotor carrier and the cover.

5. The hybrid drive module of claim 4, wherein:
the connection element includes a shoulder portion with a surface;
the at least one second rivet extends from the surface in an axial direction; and,
at least a portion of the surface is engaged with the cover.

6. The hybrid drive module of claim 4, wherein the rotor carrier is non-rotatably connected to the cover solely by the at least one second rivet.

7. The hybrid drive module of claim 1, wherein the connection element:
is made of the third piece of material in a form of a plate;
includes a surface in contact with the cover; and,
is non-rotatably connected to the cover by at least one weld.

8. The hybrid drive module of claim 7, wherein the rotor carrier is non-rotatably connected to the cover solely by the at least one weld.

9. The hybrid drive module of claim 1, further comprising:
an input part arranged to receive torque; and,
a disconnect clutch including:
at least one first clutch plate non-rotatably connected to the rotor carrier;
an inner carrier non-rotatably connected to the input part;
at least one second clutch plate non-rotatably connected to the inner carrier; and,
a piston plate axially displaceable to open and close the clutch.

10. A method of assembling a hybrid drive module including a rotor carrier made of a first piece of material and including at least one rivet, comprising:
inserting the at least one rivet through at least one respective opening in a cover for a torque converter, the cover made of a second piece of material different from the first piece of material;
deforming the at least one rivet to fixedly secure the rotor to the cover;
fixing an impeller for the torque converter to the cover; and,
installing a turbine and stator for the torque converter.

11. The method of claim 10, wherein the at least one rivet is formed from the first piece of material.

12. The method of claim 10, wherein the at least one rivet is formed of a third piece of material, different from the first piece of material and fixed to the first piece of material.

13. The method of claim 10, further comprising:
non-rotatably connecting at least one first clutch plate for a disconnect clutch to the rotor carrier;
non-rotatably connecting an inner carrier for a disconnect clutch to an input part arranged to receive torque for the hybrid drive module;
non-rotatably connecting at least one second clutch plate for the disconnect clutch to the inner carrier; and,
installing a piston plate axially displaceable to open and close the disconnect clutch.

14. A hybrid drive module, comprising:
a torque converter including:
a cover formed of a piece of material;
an impeller; and,
a turbine; and,
a rotor carrier:
formed of a piece of aluminum different from the piece of material;
arranged to non-rotatably connect to a rotor for an electric motor; and,
including a connection element:
formed of a piece of non-aluminum material different from the piece of material;
partially embedded in the piece of aluminum; and,
non-rotatably connected to the rotor carrier and the cover.

15. The hybrid drive module of claim 14, wherein the connection element includes at least one rivet passing through the material forming the cover and non-rotatably connected to the cover.

16. The hybrid drive module of claim 15, wherein:
the connection element includes a shoulder portion with a surface;
the at least one rivet extends from the surface in an axial direction; and,
at least a portion of the surface is engaged with the cover.

17. The hybrid drive module of claim 15, wherein the rotor carrier is non-rotatably connected to the cover solely by the at least one rivet.

18. The hybrid drive module of claim 14, wherein the connection element:
is an annular plate;
includes a surface in contact with the cover; and,
is non-rotatably connected to the cover by at least one weld.

19. The hybrid drive module of claim 18, wherein the rotor carrier is non-rotatably connected to the cover solely by the at least one weld.

20. The hybrid drive module of claim 14, further comprising:
an input part arranged to receive torque; and,
a disconnect clutch including:
at least one first clutch plate non-rotatably connected to the rotor carrier;
an inner carrier non-rotatably connected to the input part;
at least one second clutch plate non-rotatably connected to the inner carrier; and,
a piston plate axially displaceable to open and close the clutch.
